(19) United States
(12) Patent Application Publication
(10) Pub. No.: US 2010/0088130 A1
(43) Pub. Date: Apr. 8, 2010

(54) Discovering Leaders in a Social Network

(75) Inventors: Francesco Bonchi, Barcelona (ES); Laks V.S. Lakshmanan, Vancouver (CA); Amit Goyal, Vancouver (CA)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 12/246,668

(22) Filed: Oct. 7, 2008

(51) Int. Cl. G06Q 10/00; G06F 17/30

(52) U.S. Cl. 705/7; 707/E17.014

(57) ABSTRACT

Particular embodiments of the present invention are related to discovering the identity of leaders who influence the performance of particular actions in the context of a social network.

### TECHNICAL FIELD

The present disclosure generally relates to targeted advertising systems.

### BACKGROUND

As the popularity of the Internet has increased, so has the prevalence of social networking websites and applications. Generally speaking, a social network refers to an application or service that facilitates the building online communities of people who share interests and activities, or who are interested in exploring the interests and activities of others. Many social network services are web-based and provide a variety of ways for users to interact, such as e-mail and instant messaging services. Some examples of social networking websites are del.icio.us (http://del.icio.us./), facebook (http://www.facebook.com), Yahoo! Movies (http://movies.yahoo.com), Yahoo! Music (http://music.yahoo.com), Flickr (http://www.flickr.com), and others.

In many social networks, a particular user may allow their social contacts to view various actions taken by the particular user. As an example, the user may use del.icio.us to perform the action of bookmarking a web Uniform Resource Locator (URL) and tagging it with a descriptive tag. As another example, the user may use Yahoo! Movies to perform the action of rating and/or reviewing a movie. As a further example, the user may perform the action of writing a review of a product in a personal blog, such as a personal blog in facebook.

The users social contacts may view the user's actions on the social network and may be interested in performing the same or similar actions (e.g., visiting a website tagged by the user in del.icio.us, purchasing or renting a movie reviewed by the user at Yahoo! Movies, or purchasing a product reviewed on the user's personal blog). Accordingly, the user may be said to have influenced actions performed by his or her social contacts. In a social network, such actions may further propagate to contacts of the user's contacts.

If such influence patterns repeat with statistical significance, a user or users that generate such influence may be said to be “leaders” that set trends for performing certain actions. Influence propagation and leadership are often considered in the context of viral marketing. The basic concept behind viral marketing is that there is a probability that a person will perform an action if his or her contacts have also performed it. Thus, the identification of such leaders may be of interest for numerous reasons, including for targeted marketing and advertising, for example.

### SUMMARY

The present invention provides methods, apparatuses and systems directed to discovering the identity of leaders who influence the performance of particular actions in the context of a social network. Particular implementations of the invention are directed to determining the identity of leaders from a data structure consisting of a representation of a social network and the various actions performed by users of the social network.

### DESCRIPTION OF THE DRAWINGS

FIG. 1 is a schematic diagram that illustrates an example network environment in which particular implementations of the invention may operate.

FIG. 2 is a schematic diagram illustrating a client host environment to which implementations of the invention may have application.

FIG. 3(a) illustrates an example social graph for a social network to which implementations of the invention may have application.

FIG. 3(b) illustrates an example log of actions performed by users depicted in the example social graph of FIG. 3(a), to which implementations of the invention may have application.

FIGS. 3(c) and 3(d) illustrate example propagation graphs for actions set forth in the example action log depicted in FIG. 3(b).

FIG. 4(a) illustrates a sample propagation graph for a particular action in a social network.

FIGS. 4(b) and 4(c) each illustrate an influence graph derived from the propagation graph depicted in FIG. 4(a).

FIG. 5(a) illustrates an example action log with a window W positioned at the bottom-most position of the action log, to which implementations of the invention have application.

FIG. 5(b) illustrates a possible sub-graph of vertices present in window W of the action log depicted in FIG. 5(a).

FIG. 5(c) illustrates example influence vectors for vertices present in the action log depicted in FIG. 5(a).

FIG. 5(d) illustrates an example queue that may be used to track users associated with each bit position in the influence vectors depicted in FIG. 5(c).

FIG. 5(e) illustrates an example lock bit vector that may be used to track free bit positions in the influence vectors depicted in FIG. 5(c).

FIGS. 6, 7, and 8 are flow charts showing example methods associated with particular implementations of the invention.

FIG. 9 is a schematic diagram illustrating an example computing system architecture that may be used to implement one or more of physical servers depicted in FIG. 1.

### DESCRIPTION OF EXAMPLE EMBODIMENT(S)

### A. Overview

Particular embodiments of the present invention are related to discovering the identity of leaders who influence the performance of particular actions in the context of a social network. Given a data structure consisting of a representation of a social network and the various actions performed by users of the social network, the propagation of influence for performing each of the actions may be determined. This propagation of influence may then be used for identifying leaders that set trends for performing certain actions. For example, a user may be identified as a leader with respect to an action if the user performed an action and within a chosen time, a sufficient number of other users with social network ties to the user also performed the action.

In addition, the propagation of influence may also be analyzed to determine if a particular leader is a “tribe leader,” meaning that the user leads a fixed or similar set of users (a “tribe”) with respect to certain actions. For example, if a user is found to be a leader with respect to the same or a similar group of other users for two or more actions, the user may be determined to be a “tribe leader.”

Furthermore, analysis of the propagation of influence may be used to determine if a particular leader is a “genuine leader.” In a social network, the leadership of one user with respect to an action may be “subsumed” by others, such that analysis may indicate that a particular user is a leader, when in fact such user has merely followed another user, meaning that the followed user may indeed be the “genuine leader” with respect to the action.

The present invention can be implemented in a variety of manners, as discussed in more detail below. Other implementations of the invention may be practiced without some or all of specific details set forth below. In some instances, well known structures and/or processes have not been described in detail so that the present invention is not unnecessarily obscured.

A.1. Example Network Environment

Particular implementations of the invention operate in a wide area network environment, such as the Internet, including multiple network addressable systems. Network cloud 60 generally represents one or more interconnected networks, over which the systems and hosts described herein can communicate. Network cloud 60 may include packet-based wide area networks (such as the Internet), private networks, wireless networks, satellite networks, cellular networks, paging networks, and the like.

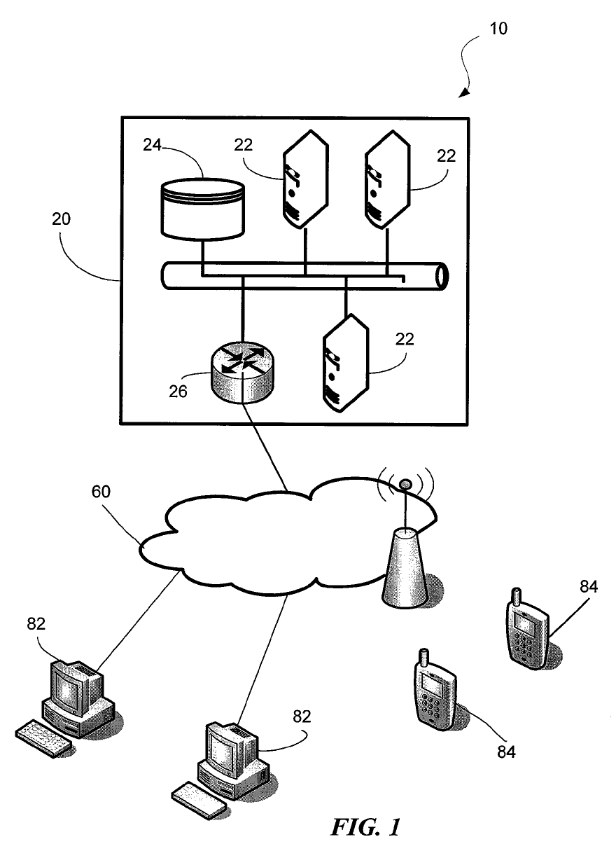

As FIG. 1 illustrates, a particular implementation of the invention can operate in a network environment comprising network application hosting site 20, such as an informational web site, social network site and the like. Although FIG. 1 illustrates only one network application hosting site, implementations of the invention may operate in network environments that include multiples of one or more of the individual systems and sites disclosed herein. Client nodes 82, 84 are operably connected to the network environment via a network service provider or any other suitable means.

Network application hosting site 20 is a network addressable system that hosts a network application accessible to one or more users over a computer network. The network application may be an informational web site where users request and receive identified web pages and other content over the computer network. The network application may also be a search platform, an on-line forum or blogging application where users may submit or otherwise configure content for display to other users. The network application may also be a social network application allowing users to configure and maintain personal web pages. The network application may also be a content distribution application, such as Yahoo! Music Engine®, Apple® iTunes®, podcasting servers, that displays available content, and transmits content to users.

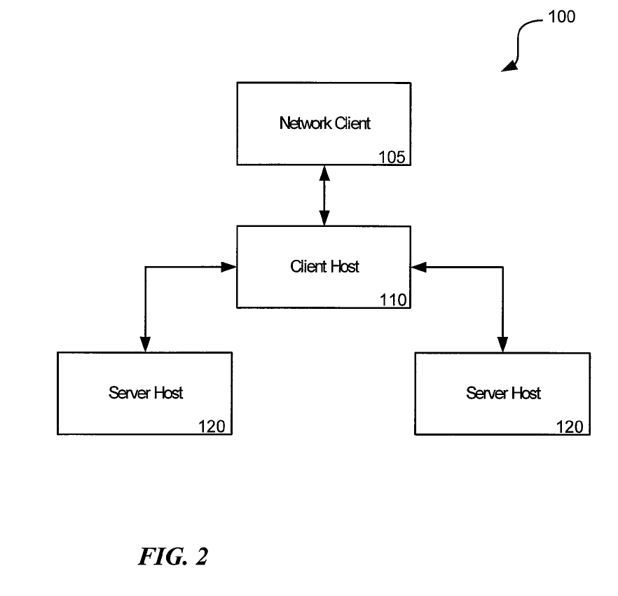

Network application hosting site 20, in one implementation, comprises one or more physical servers 22 and content data store 24. The one or more physical servers 22 are operably connected to computer network 60 via a router 26. The one or more physical servers 22 host functionality that provides a network application (e.g, a news content site, etc.) to a user. As discussed in connection with FIG. 2, in one implementation, the functionality hosted by the one or more physical servers 22 may include web or HTTP servers, ad serving systems, geo-targeting systems, and the like. Still further, some or all of the functionality described herein may be accessible using an HTTP interface or presented as a web service using SOAP or other suitable protocols.

Content data store 24 stores content as digital content data objects. A content data object or content object, in particular implementations, is an individual item of digital information typically stored or embodied in a data file or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc. Structurally, content data store 24 connotes a large class of data storage and management systems. In particular implementations, content data store 24 may be implemented by any suitable physical system including components, such as database servers, mass storage media, media library systems, and the like.

Network application hosting site 20, in one implementation, provides web pages, such as front pages, that include an information package or module describing one or more attributes of a network addressable resource, such as a web page containing an article or product description, a downloadable or streaming media file, and the like. The web page may also include one or more ads, such as banner ads, text-based ads, sponsored videos, games, and the like. Generally, web pages and other resources include hypertext links or other controls that a user can activate to retrieve additional web pages or resources. A user “clicks” on the hyperlink with a computer input device to initiate a retrieval request to retrieve the information associated with the hyperlink or control.

FIG. 2 illustrates the functional modules of a client host server environment 100 within network application hosting site 20 according to one particular implementation. As FIG. 2 illustrates, network application hosting site 20 may comprise one or more network clients 105 and one or more client hosts 110 operating in conjunction with one or more server hosts 120. The foregoing functional modules may be realized by hardware, executable modules stored on a computer readable medium, or a combination of both. The functional modules, for example, may be hosted on one or more physical servers 22 and/or one or more client computers 82, 84.

Network client 105 may be a web client hosted on client computers 82, 84, a client host 110 located on physical server 22, or a server host located on physical server 22. Client host 110 may be an executable web or HTTP server module that accepts HyperText Transport Protocol (HTTP) requests from network clients 105 acting as a web clients, such web browser client applications hosted on client computers 82, 84, and serving HTTP responses including contents, such as HyperText Markup Language (HTML) documents and linked objects (images, advertisements, etc.). Client host 110 may also be an executable module that accepts Simple Object Access Protocol (SOAP) requests from one or more client hosts 110 or one or more server hosts 120. In one implementation, client host 110 has the capability of delegating all or part of single or multiple requests from network client 105 to one or more server hosts 120. Client host 110, as discussed above, may operate to deliver a network application, such as an informational web page or an internet search service.

In a particular implementation, client host 110 may act as a server host 120 to another client host 110 and may function to further delegate requests to one or more server hosts 120 and/or one or more client hosts 110. Server hosts 120 host one or more server applications, such as an ad selection server, sponsored search server, content customization server, and the like.

A.2. Client Nodes & Example Protocol Environment

A client node is a computer or computing device including functionality for communicating over a computer network. A client node can be a desktop computer 82, laptop computer, as well as mobile devices 84, such as cellular telephones, personal digital assistants. A client node may execute one or more client applications, such as a web browser, to access and view content over a computer network. In particular implementations, the client applications allow users to enter addresses of specific network resources to be retrieved. These addresses can be Uniform Resource Locators, or URLs. In addition, once a page or other resource has been retrieved, the client applications may provide access to other pages or records when the user “clicks” on hyperlinks to other resources. In some implementations, such hyperlinks are located within web pages and provide an automated way for the user to enter the URL of another page and to retrieve that page. The pages or resources can be data records including as content plain textual information, or more complex digitally encoded multimedia content, such as software programs or other code objects, graphics, images, audio signals, videos, and so forth.

The networked systems described herein can communicate over the network 60 using any suitable communications protocols. For example, client nodes 82, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as the HyperText Transfer Protocol (HTTP) and other communications protocols, such as HTTP-S, FTP, SNMP, TELNET, and a number of other protocols, may be used. In addition, a server in one interaction context may be a client in another interaction context. Still further, in particular implementations, the information transmitted between hosts may be formatted as HyperText Markup Language (HTML) documents. Other structured document languages or formats can be used, such as XML, and the like.

In some client-server protocols, such as the use of HTML over HTTP, a server generally transmits a response to a request from a client. The response may comprise one or more data objects. For example, the response may comprise a first data object, followed by subsequently transmitted data objects. In one implementation, for example, a client request may cause a server to respond with a first data object, such as an HTML page, which itself refers to other data objects. A client application, such as a browser, will request these additional data objects as it parses or otherwise processes the first data object.

Mobile client nodes 84 may use other communications protocols and data formats. For example, mobile client nodes 84, in some implementations, may include Wireless Application Protocol (WAP) functionality and a WAP browser. The use of other wireless or mobile device protocol suites are also possible, such as NTT DoCoMo's i-mode wireless network service protocol suites. In addition, the network environment may also include protocol translation gateways, proxies or other systems to allow mobile client nodes 84, for example, to access other network protocol environments. For example, a user may use a mobile client node 84 to capture an image and upload the image over the carrier network to a content site connected to the Internet.

A.3. Example Operation

In a social networking service, each user of the social network may create a network profile (e.g., username, password, and/or biographical information) via a client node 82, 84. For example, a user may access the social network via an application program available at the client node and/or via a website for the social network. Via client nodes 82, 84, each user may also specify other users in the social network to which the user has a social tie. In this disclosure, the terms “social tie” and “tie” may be used to indicate a social relationship between two users in a social network (e.g., a “friend,” “buddy,” “connection,” “link,” etc.), while the term “contact” may be used to indicate a user for which a user has a social tie. In addition to a social tie existing based on a declared relationship between users, a social tie may also be derived by the social networking service on the basis of shared interests and/or biographical information of the users. The social networking application, user biographical information, social ties, and contact information may be hosted at network application hosting site 20. Users using client nodes 82, 84 may access the social networking application via network cloud 60.

Once a user's contacts have been identified, a user may be able to access the social networking application website and/or application to view some or all of the profile information of his or her contacts, including, for example, actions performed by the contacts.

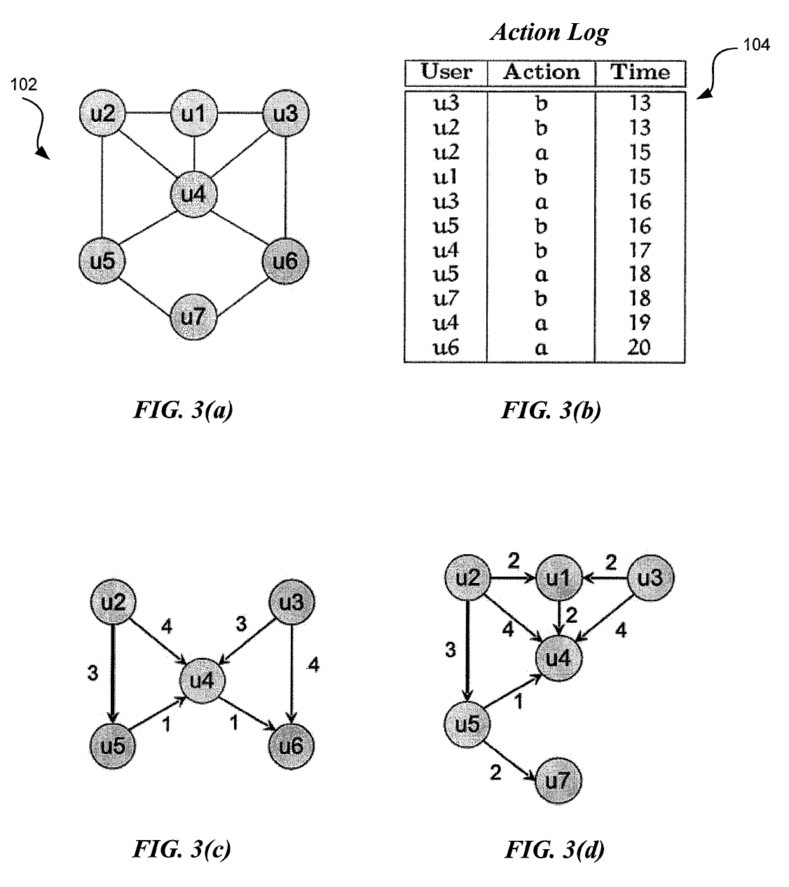

FIG. 3(a) illustrates an example social graph 102 for a social network, wherein vertices of graph 102 indicate users in the social network, and the edges of graph 102 depict the existence of social ties between users in the social network. For example, an edge connecting two vertices may indicate that such users are contacts (e.g., “friends”). For example, as depicted in graph 102, user u1 is a contact of users u2, u3, and u4, but not a contact of users u5, u6, and u7. Using mathematical notations in accordance with set theory and graph theory, any social graph for a social network (e.g., graph 102) may be defined as an undirected graph G=(V, E) wherein the vertices denote users of the social network and the edges denote a social tie between the users.

FIG. 3(b) illustrates an example log 104 of actions performed by the users depicted in graph 102. As seen in FIG. 3(b), an action log (e.g., log 104) may be a relation Actions (User, Action, Time), including one or more tuples (u, a, t) indicating that a user u performed action a at time t. Such an action log may include such a tuple for one or more actions performed by one of more users of the social network. By linking the actions of a social graph and an action log (e.g., a projection of Actions on the first column is contained in the set of vertices V of the social graph G), the propagation of influence for various actions can be determined. For example, it can be said that an action a propagates from a user vᵢ to a user vⱼ if a social tie exists between vᵢ and vⱼ, and the actions log includes tuples (vᵢ, a, tᵢ) and (vⱼ, a, tⱼ), such that tᵢ<tⱼ. This can be alternatively stated using set theory notation as follows:
Action a ∈ A propagates from user Vᵢ to user Vⱼ iff (vᵢ, vⱼ) ∈ E and ∃ (vᵢ, a, tᵢ), (vⱼ, a, tⱼ) ∈ Actions with tᵢ<tⱼ.

Having defined the concept of propagation, a propagation graph for one or more actions may be defined. A propagation graph PG(a)=(V(a), E(a)) with respect to an action a may include vertices for users who performed a, edges connecting the vertices in the direction of propagation of a, and edge weights denoting the elapsed time of the propagation of a from one user to another. Alternatively stated using graph theory and set theory notation, PG(a)=(V(a), E(a)) may be defined as:
V(a)={v | ∃t: (v, a, t) ∈ Actions}; there is a directed edge vᵢ→vⱼ of weight Δt whenever a propagates from vᵢ to vⱼ, with (vᵢ, a, tᵢ), (vⱼ, a, tⱼ) ∈ Actions, where Δt=tⱼ−tᵢ.

FIGS. 3(c) and 3(d) illustrate example propagation graphs for actions a and b depicted in FIG. 3(b), respectively, in accordance with the propagation graph definition set forth above.

Because influence can propagate transitively without regard to the elapsed time of the propagation, it may be beneficial to not only determine the propagation of an action a, but also to determine the extent of propagation over a propagation time threshold. Application of a propagation time threshold π provides a limit on how long after the performance of an action by a first user the same action performed by a second user is regarded as having been influenced by the first user. Applying the concept of a propagation time threshold π to a propagation graph PG(a), a user influence graph Inf_{π}(u, a) for each action a with respect to a user u may be defined as follows:
Given action a, a user u, and a propagation time threshold π, Inf_{π}(u, a) is the sub-graph PG(a) rooted at u, such that it consists of those vertices of PG(a) which are reachable from u in PG(a) and such that every path from u to any other vertex in Inf_{π}(u, a) has an elapsed time at most Inf_{π}(u, a).

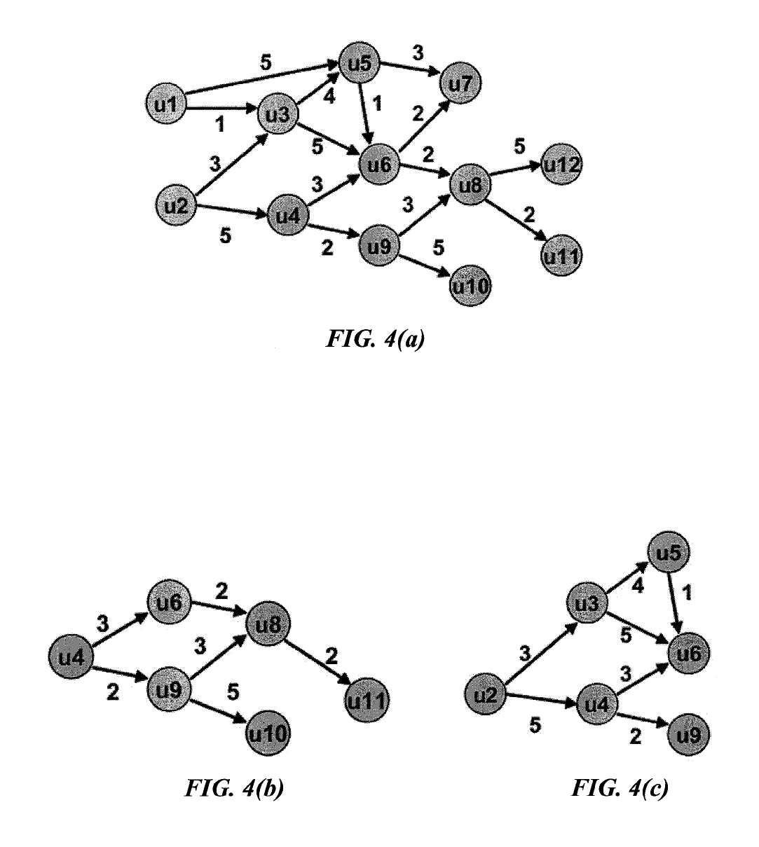

FIG. 4(a) depicts a sample propagation graph PG(a) for an action a. Using the definition of influence graph above, FIG. 4(b) depicts an influence graph Inf₈(u4, a) derived from the propagation graph in FIG. 4(a), while FIG. 4(c) depicts an influence graph Inf₈(u2, a) derived from the propagation graph in FIG. 4(a). Thus, FIG. 4(b) may depict user u4 that has performed an action a and the other users that have also performed a within a time 8. Similarly, FIG. 4(c) may depict user u2 that has performed an action a and the other users that have also performed a within a time 8.

Given a particular influence graph Inf_{π}(u, a), a user u may be defined as a leader with respect to an action a if such user u has achieved at least a certain influence threshold ψ on other users to perform the action within the propagation time threshold π. Thus, to determine if a user is a leader with respect to the action, the number of vertices of the corresponding influence graph may be compared to the influence threshold ψ. However, in some embodiments, a user may need to act as a leader with respect to more than one action (e.g., a predefined number of actions in a social network) in order to be defined as a leader in that social network. Accordingly, an action threshold σ may be set such that a user is defined as a leader with respect to the social network only if the user is a leader with respect to a number of actions greater or equal to the action threshold σ. Thus, again applying graph theory and set theory notation, a leader may be defined as follows:
Given a set of actions I ⊂ A, and thresholds π, ψ, and σ, a user v ∈ V is a leader iff:
   ∃S ⊂ I, |S|≧σ: ∀a ∈ S.size(Inf_{π}(v, a))≧ψ.

Thus, under the above definition for leader, a user is a leader if, for a sufficient number of actions, at least a sufficient number of other users are influenced to perform the actions within a specified duration from when the user performed the actions. Notably, the above definition does not require the set of influenced users for each of the different actions to be the same. However, “tribe leaders” that influence the same or a similar group of users may be defined using graph theory and set theory notation as follows:
Given a set of actions I ⊂ A, and thresholds π, ψ, and σ, a user v ∈ V is a tribe leader iff:
   ∃S ⊂ I, |S|≧σ, ∃U ⊂ V, |U|≧ψ. ∀a ∈ S.U ⊂ (Inf_{π}(v, a)).

In addition to using an absolute threshold for the number of actions for which a user acts as a leader, a “confidence” measure may also be applied based on a ratio and/or percentage of actions of which user has performed in which the user is a leader. For example, a “leadership confidence” of a user v may be defined as the ratio conj(v)=|L(v)|/|P(v)| where, using set theory notation:
L(v)={a ∈ A | v is a leader with respect to a}; and
P(v)={a ∈ A | v performed a}.

Accordingly, given a set of actions I ⊂ A, and a confidence threshold 0<φ<1, a user v may be said to be a “confidence leader” if the user v is a leader in the social network (as defined above) and conj(v)≧φ.

In certain instances, it may happen that a particular user acts as a leader in accordance with the concepts defined above, but in actuality often follows the same “true” or “genuine” leader. To avoid this problem, a “genuineness” measure may be applied to determine how “true” or “genuine” a user's leadership is. Again using set theory notation, a genuineness ratio gen(v) may be defined as:
   |{a ∈ L(v) | ˜∃u ∈ V: us is leader for a ̂ v ∈ (Inf₉₀ (u, a)}|/|L(v)|

Stated another way, the genuineness ratio gen(v) may equal the fraction of actions led by a user v for which v's leadership is genuine, in that it is not a consequence of v being present in the influence graph of some other leader with respect to that action. Accordingly, given a set of actions I ⊂ A, and a genuineness threshold 0<γ<1, a user v may be said to be a “genuine leader” provided that the genuineness ratio of v is above the genuineness threshold, e.g., gen(v)≧γ.

Both the genuineness and confidence concepts described above may be applied to “tribe leaders” as well as “leaders.”

Having defined various concepts regarding the determination of leaders in a social network, the methods described below may facilitate extracting the identity of leaders from an action log Actions. In many instances, an action log may be quite large and may include millions of tuples. However, by applying a time interval with a time equal to the propagation time threshold π, a sub-graph of users performing relevant actions within the time interval may be small enough to be manageable from a data processing and analysis standpoint. In fact, if actions in an action log are stored in chronological order, the method described below may be able to extract leaders and tribe leaders with a single pass through the actions log.

If the action log Actions is stored in chronological order, and given a propagation time threshold π, Actions may be scanned by means of a window of width π. Thus, at any position of the window, a subset of tuples in Actions falls in the window. If W denotes the current position of the window, a sub-graph of the social graph G may be defined, such that G_{W}=(V_{W}, E_{W}), where V_{W} is the set of users who performed at least one action within the window W and an edge is present in E_{W} if and only if it is present in E and both of its endpoints are in V_{W}.

By sliding the window chronologically backwards through Actions, an influence matrix IM_{π}(U, A) may be computed, where U is the number of users and A is the number of actions. An entry IM_{π}(u, a) in the matrix may be the number of users influenced by u with respect to action a within a time π. From this influence matrix, leaders may be determined, as set forth in greater detail below.

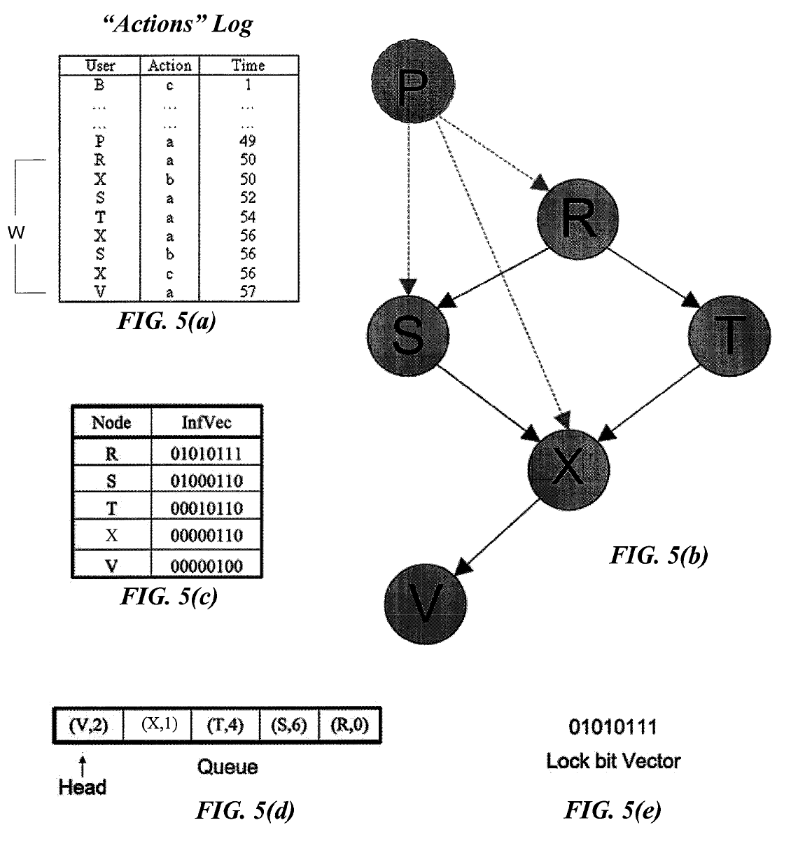

To illustrate the methods for determining leaders and tribe leaders, the running example depicted in FIGS. 5(a)-5(e) will be used. FIG. 5(a) illustrates an example action log Actions with window W positioned at the bottom-most position of Actions. FIG. 5(b) illustrates a possible sub-graph G_{W} of G with vertices corresponding to users present in window W. Vertex P in dashed lines and their incident edges correspond to those vertices not yet “visible” in window W.

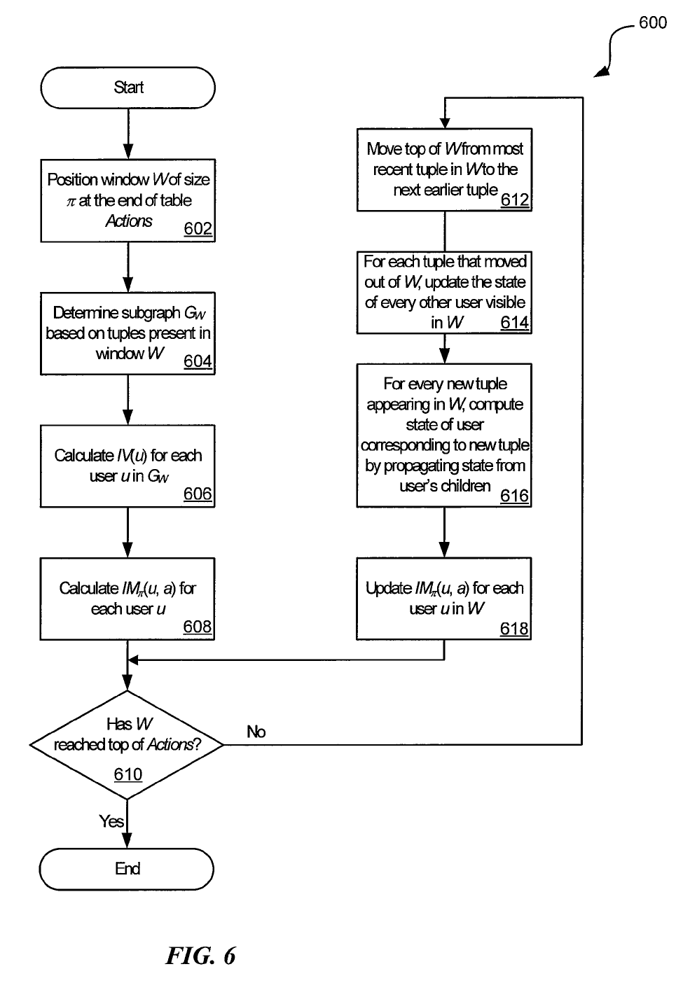

FIG. 6 illustrates a flow chart of an example method 600 that may be implemented by a social networking application and/or other application (e.g., a social networking application executing on a network application hosting site 20) for computing an influence matrix. For simplicity of explanation, method 600 and the other methods described below may be described with respect to only one action a, although such methods may simultaneously track the influence propagation information for more than one action. As FIG. 6 illustrates, method 600 may begin at step 602 with window W positioned at the bottom of the action log Actions. At step 604, the sub-graph G_{W} visible in window W may be determined based on the tuples present in W. At step 606, the influence vector IV(u) for each vertex/user u in G_{W} may be calculated, each influence vector indicating the “state” of the vertex/user u with respect to an action, wherein the “state” represents the users influenced by a given user with respect to the action. The influence vector may include a bit vector such as the bit vectors shown in the table of FIG. 5(c). At step 608, the cells of the influence matrix IM_{π}(u, a) corresponding to each user may be calculated as the state for each vertex/user is updated. Each cell of IM_{π}(u, a) may be calculated by simply determining from a corresponding IV(u) how many users are influenced by user u with respect to action a.

At step 610, a determination may be made regarding whether W has reached the top of the Actions log. If W has reached the top of Actions, method 600 may end. Otherwise, if W has not reached the top of Actions, method 600 may proceed to step 612. At step 612, window W may be moved from the most recent tuple in W to the next earlier tuple. At step 614, for every tuple that moved out of the window at step 612, the state of every other user visible in W may be updated, as described in greater detail below. At step 616, for every new tuple appearing in W at step 612, the state of the corresponding vertex/user may be computed by propagating the state of its children vertices in the visible sub-graph G_{W}, as also described in greater detail below. At step 618, entries in the influence matrix IM_{π}(u, a) may be computed based on the application of the update and propagate steps discussed above. For example, each entry in IM_{π}(u, a) may be dynamically updated during each pass through steps 610-618 to include the maximum number of users that have ever appeared in the influence vector IV(u) for a given action a. After completion of step 618, method 600 may proceed again to step 610.

The update and propagate steps described above may be used to efficiently update each influence vector IV and/or propagate state from children vertices to their parent vertices. Because a graph G may be large and only a relatively small number of users may be visible in window W at a given time, it may be beneficial to optimize the number and usage of bits in each influence vector. However, such an optimization requires that bits in each IV be dynamically allocated as W moves through Actions. To address this issue, a lock map may be maintained for each position of W. In certain embodiments, lock map entries may be maintained as entries in a queue Queue(a), as shown in FIG. 5(d). For example, as shown in FIG. 5(d), user R may be assigned the 0th bit, user S may be assigned the 6th bit, etc. In addition, to facilitate quick allocation of “free” bits in the lock map, a lock bit vector, such as that depicted in FIG. 5(e), for example, may be maintained wherein set bits may correspond to bits or locks presently used by vertices in the present sub-graph G_{W}, and zero bits may correspond to “free” bit positions. For example, as depicted in FIGS. 5(d) and 5(e), bit positions 0, 1, 2, 4 and 6 of influence vectors depicted in FIG. 5(c) may be used by vertices/users R, X, V, T, and S, respectively. As window W moves in accordance with method 600, the lock map entries and the lock bit vector may be updated as described below.

As discussed above, the state of each vertex/user with respect to an action may be represented by an influence vector IV. Accordingly, the users influenced by a particular user may be determined simply by reference to an influence vector for the particular user and the present lock map. For example, in the example depicted in FIGS. 5(c) and 5(d), the influence vector of S (010000110) indicates that the users influenced by S correspond to bit positions 1, 2 and 6. Bit positions 1 and 2 correspond to vertices/users X and V, respectively, which are the users influenced by S.

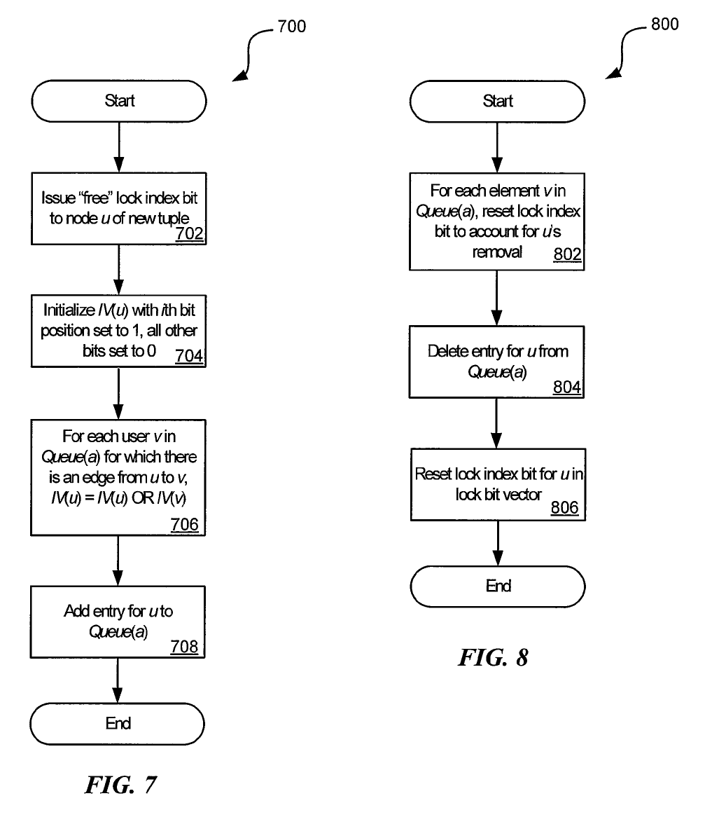

FIG. 7 illustrates a flow chart of an example method 700 that may be implemented to propagate the state of children vertices to a parent vertex, e.g., as described with respect to step 616 of method 600, above. Method 700 may be implemented by a social networking application and/or other application (e.g., a social networking application executing on a network application hosting site 20). Method 700 may be executed when a new tuple (u, a, t) moves into window Win accordance with method 600. At step 702, a “free” lock index bit may be issued to vertex/user u of the new tuple. For example, in some embodiments the least significant bit of the lock bit vector having a value of 0 may be assigned to the vertex/user u. At step 704, the influence vector IV(u) may be initialized with zeroes in each bit position except for the bit position i corresponding to the bit of the lock bit vector issued to u. The ith bit position of IV(u) may be initialized with a value of 1.

At step 706, Queue(a) corresponding to the action a of the new tuple may be traversed to determine each vertex/user represented in Queue(a) which a child of u. For each particular vertex represented in Queue(a) for which there exists an edge from u to the particular vertex, then IV(u) may be updated as the bitwise logical OR of IV(u) and the IV of the particular user. At step 708, an entry corresponding to u may be added to Queue(a).

While method 700 may be utilized to update and propagate user states with respect to a tuple newly added to window W, user states may also require updating when window W moves up and a tuple drops out of W. When W moves up to a new tuple, a vertex/user may drop out of the sub-graph corresponding to W. In such a case, states of the remaining vertices/users may need to be updated.

FIG. 8 illustrates a flow chart of an example method 800 that may be implemented to update the status of vertices/users, e.g., as described with respect to step 614 of method 600, above. Method 800 may be implemented by a social networking application and/or other application (e.g., a social networking application executing on a network application hosting site 20). Method 800 may be executed when a tuple (u, a, t) “drops out” of window Win accordance with method 600.

At step 802, Queue(a) corresponding to the action a of the newly-dropped tuple may be traversed, and for each particular user v represented in Queue(a), the bit position within IV(v) corresponding to the lock index bit of u may be reset to account for u's removal from the sub-graph. At step 804, the entry in Queue(a) corresponding to user u may be deleted. At step 806, the lock index bit for u in the lock bit vector may be reset, essentially “releasing” the lock on the bit position.

To illustrate the operation of methods 600, 700, and 800, reference is again made to FIGS. 5(a)-5(e). When window W is at its bottom-most position, the IV is computed for each user in W with respect to each action, and the lock bit vector Queue(a) for each action is also initialized. From the bottom-most position, W may move up one tuple such that vertex/user V drops off the window and vertex/user P may enter the window. The state of vertices R, S, T, and X which are present in both the old and new window may be updated. This update is done by zeroing the bit in each influence vector corresponding to V, for example bit 2 in the particular example illustrated in FIGS. 5(a)-5(e). Next, by examining the lock bit vector, “free” bits of the lock bit vector (and consequently, bits in each influence vector) may be assigned to P. In order to compute the influence vector of the new vertex/user P, the states of its respective children vertices are propagated. For example, for user P, its influence vector may be computed as its default influence vector bitwise OR'ed with the influence vectors of each of children R, S, and X, as detailed in step 706 of method 700.

As noted above, the influence vector of each user with respect to each action may be used to calculate the influence matrix IM_{π}(u, a). For example, a particular entry in IM_{π}(u, a) may be equal to the maximum number of influenced vertices/users indicated in the influence vector IV(u) with respect to each action.

Once the influence matrix is available, leaders may be determined. For example, for a given user u, an action threshold σ, and an influence threshold ψ, a set L(u) may be defined as L(u)={a | IM_{π}(u, a)>ψ}. A user u may be determined to be a leader if |L(u)|≧σ. Thus, leaders may be determined by scanning the various rows of the influence matrix. Similarly, given a confidence threshold φ, the confidence ratio conj(u) may be calculated as |L(u)|/|P(u)|, wherein P(u)={a | IM_{π}(u, a)>0}, and u may be determined to be a confidence leader when conj(u)≧φ.

The genuineness ratio gen(u) may be computed by maintaining a counter fake(u) for each user u. The counter fake(u) may be incremented whenever u is found to be a leader for some action a and in the influence graph Inf_{π}(v, a) of another leader with respect to a. The genuineness ratio for user u, gen(u), may then be calculated as gen(u)=(|L(u)|−fake(u))/|L(u)|, and u may be determined to be a genuine leader when gen(u)≧γ.

The computed influence matrix may itself be inadequate for computing tribe leaders. Accordingly, an influence cube IC_{π}(u, a, v) may be used. Each entry of IC_{π}(u, a, v) may be a Boolean entry such that IC_{π}(u, a, v)=1 if user v was influenced by user u with respect to action a with respect to an underlying time threshold π, and IC_{π}(u, a, v)=0 otherwise.

From the influence cube, it may be determined whether u is a tribe leader by means of frequent itemsets mining. In fact, in each array IC_{π}(u, a, *) (where “*” denotes a “don't care”) as a transaction of items in which items correspond to candidate influenced users. Stated another way, for a given user u, IC_{π}(u, a, *) provides a transaction corresponding to every action a. Thus, a “tribe” may be seen as an itemset, and determining tribe leaders may be seen as finding frequent itemsets larger than a given influence threshold ψ on the minimum acceptable tribe size, wherein the itemset does not include u if u is the user for which a determination of tribe leadership is being made. In other words, a user u may be determined to be a tribe leader if there is at least one itemset of size ψ (not containing u) that has a frequency of σ or more in the transaction database IC_{π}(u, a, *).

In certain embodiments, it is not necessary to explicitly compute the influence cube. In fact, real-life datasets may be sparse with respect to users performing actions, meaning a direct implementation of an influence cube may be inefficient with respect to storage and memory space. However, the transaction database IC_{π}(u, a, *) can be constructed using other parameters described above. For example, given a user u and an action a, a time t may be the time at which u performed a. If t represents the beginning or “top” of a time window, a time t+π may represent the end of the window. The influence vector of u with respect to a for this particular window position may indicate the various bit positions corresponding to users influenced by user u on action a. Thus, the combination of the influence vector of u for a for window position t and the lock map may provide a compact representation of the transaction, i.e. row IC_{π}(u, a, *) in the influence cube. Once each row of the transaction database IC_{π}(u, a, *) has been calculated, tribe leaders and their tribes may be determined by determining σ-frequent itemsets of size ≧ψ (not including u) by any appropriate method for calculating frequent itemsets (e.g., “ExAMiner” as described in F. Bonchi et al, ExAMiner: Optimized level-wise frequent pattern mining with monotone restraints, Proceedings of the Third IEEE International Conference on Data Mining (ICDM '03).)

A.4. Example Computing System Architectures

While the foregoing systems and methods can be implemented by a wide variety of physical systems and in a wide variety of network environments, the client and server host systems described below provide example computing architectures for didactic, rather than limiting, purposes.

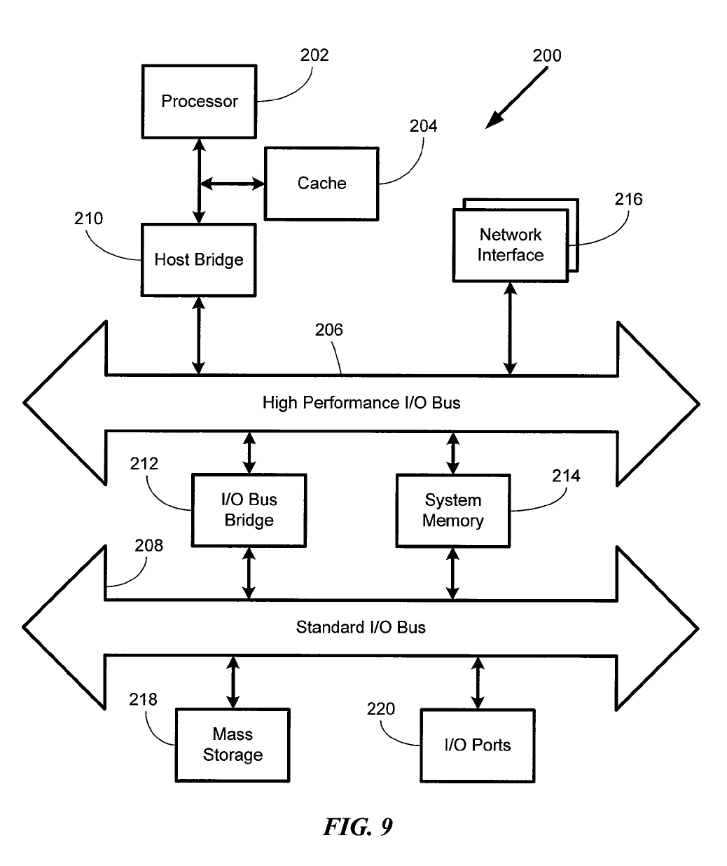

FIG. 9 illustrates an example computing system architecture, which may be used to implement a physical server. In one embodiment, hardware system 200 comprises a processor 202, a cache memory 204, and one or more software applications and drivers directed to the functions described herein. Additionally, hardware system 200 includes a high performance input/output (I/O) bus 206 and a standard I/O bus 208. A host bridge 210 couples processor 202 to high performance I/O bus 206, whereas I/O bus bridge 212 couples the two buses 206 and 208 to each other. A system memory 214 and a network/communication interface 216 couple to bus 206. Hardware system 200 may further include video memory (not shown) and a display device coupled to the video memory. Mass storage 218, and I/O ports 220 couple to bus 208. Hardware system 200 may optionally include a keyboard and pointing device, and a display device (not shown) coupled to bus 208. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 200 are described in greater detail below. In particular, network interface 216 provides communication between hardware system 200 and any of a wide range of networks, such as an Ethernet (e.g., IEEE 802.3) network, etc. Mass storage 218 provides permanent storage for the data and programming instructions to perform the above described functions implemented in the location server 22, whereas system memory 214 (e.g., DRAM) provides temporary storage for the data and programming instructions when executed by processor 202. I/O ports 220 are one or more serial and/or parallel communication ports that provide communication between additional peripheral devices, which may be coupled to hardware system 200.

Hardware system 200 may include a variety of system architectures; and various components of hardware system 200 may be rearranged. For example, cache 204 may be on-chip with processor 202. Alternatively, cache 204 and processor 202 may be packed together as a “processor module,” with processor 202 being referred to as the “processor core.” Furthermore, certain embodiments of the present invention may not require nor include all of the above components. For example, the peripheral devices shown coupled to standard I/O bus 208 may couple to high performance I/O bus 206. In addition, in some embodiments only a single bus may exist, with the components of hardware system 200 being coupled to the single bus. Furthermore, hardware system 200 may include additional components, such as additional processors, storage devices, or memories.

As discussed below, in one implementation, the operations of one or more of the physical servers described herein are implemented as a series of software routines run by hardware system 200. These software routines comprise a plurality or series of instructions to be executed by a processor in a hardware system, such as processor 202. Initially, the series of instructions may be stored on a storage device, such as mass storage 218. However, the series of instructions can be stored on any suitable storage medium, such as a diskette, CD-ROM, ROM, EEPROM, etc. Furthermore, the series of instructions need not be stored locally, and could be received from a remote storage device, such as a server on a network, via network/communication interface 216. The instructions are copied from the storage device, such as mass storage 218, into memory 214 and then accessed and executed by processor 202.

An operating system manages and controls the operation of hardware system 200, including the input and output of data to and from software applications (not shown). The operating system provides an interface between the software applications being executed on the system and the hardware components of the system. According to one embodiment of the present invention, the operating system is the Windows® 95/98/NT/XP operating system, available from Microsoft Corporation of Redmond, Wash. However, the present invention may be used with other suitable operating systems, such as the Apple Macintosh Operating System, available from Apple Computer Inc. of Cupertino, Calif., UNIX operating systems, LINUX operating systems, and the like. Of course, other implementations are possible. For example, the server functionalities described herein may be implemented by a plurality of server blades communicating over a backplane.

Furthermore, the above-described elements and operations can be comprised of instructions that are stored on storage media. The instructions can be retrieved and executed by a processing system. Some examples of instructions are software, program code, and firmware. Some examples of storage media are memory devices, tape, disks, integrated circuits, and servers. The instructions are operational when executed by the processing system to direct the processing system to operate in accord with the invention. The term “processing system” refers to a single processing device or a group of inter-operational processing devices. Some examples of processing devices are integrated circuits and logic circuitry. Those skilled in the art are familiar with instructions, computers, and storage media.

The present invention has been explained with reference to specific embodiments. For example, while embodiments of the present invention have been described as operating in connection with HTML and HTTP, the present invention can be used in connection with any suitable protocol environment. Furthermore, implementations of the invention can be used in systems directed to serving geo-targeted content other than ads to users. Other embodiments will be evident to those of ordinary skill in the art. It is therefore not intended that the present invention be limited, except as indicated by the appended claims.

What is claimed is:

1. A method for discovering a leader in a social network comprising:
analyzing an action log including information regarding the performance of a particular action by each of a plurality of users of a social network;
determining that a particular user of the plurality of users has performed the particular action;
in response to determining that the particular user has performed the particular action, analyzing information regarding the performance of the particular action by one or more other users of the plurality of users after the performance of the particular action by the particular user; and
determining whether the particular user is a leader based at least on the analysis of the subsequent performance of the particular action by the one or more other users.

2. The method of claim 1, wherein the action log includes a plurality of tuples, each tuple setting forth an action, a user that has performed the action, and a time at which the user performed the action.

3. The method of claim 1, wherein determining whether the particular user is a leader includes determining whether an actual number of users that performed the particular action after the particular user exceeds an influence threshold.

4. The method of claim 3, wherein determining whether the particular user is a leader includes determining whether the actual number of users that performed the particular action within a propagation time threshold after the performance of the particular action by the particular user.

5. The method of claim 1, wherein determining whether the particular user is a leader includes:
determining a first actual number of actions for which the particular user is a genuine leader, wherein the particular user is a genuine leader with respect to each action if the particular user is a leader with respect to such action and did not perform such action within a propagation time threshold after performance of such action by another user;
determining a second actual number of actions for which the particular user is a leader, regardless of whether the particular user is a genuine leader for such actions;
determining a genuineness ratio, wherein the genuineness ratio is defined as the ratio of the first actual number to the second actual number; and
determining whether the genuineness ratio exceeds a genuineness threshold.

6. The method of claim 1, wherein determining whether a particular user is a leader includes determining whether the particular user is a genuine leader with respect to the particular action, wherein the particular user is not a genuine leader with respect to a particular action if the particular user performed the action within a propagation time threshold after performance of the particular action by another user.

7. The method of claim 1, wherein determining whether the particular user is a leader includes determining whether an actual number of actions performed by the actual number of users after performance of the actions by the particular user exceeds an action threshold.

8. The method of claim 1, wherein determining whether the particular user is a leader includes:
determining a first actual number of actions for which the particular user is a leader;
determining a second actual number of actions performed by the particular user;
determine a confidence ratio, wherein the confidence ratio is defined as the ratio of the first actual number to the second actual number; and
determining whether the confidence ratio exceeds a confidence threshold.

9. A method of claim 1, further comprising determining whether the particular user is a tribe leader including:
determining a first number of actions performed by the one or more other users within a propagation time threshold after performance of each action by the particular user;
determining a second number of one or more other users performing the number of actions within the propagation time threshold;
identifying the particular user as a tribe leader based at least on the first number and the second number.

10. An apparatus, comprising:
one or more processors;
one or more network interfaces;
a memory; and
computer-executable instructions carried on a computer readable medium, the instructions readable by the one or more processors, the instructions, when read and executed, for causing the one or more processors to:
analyze an action log including information regarding the performance of a particular action by each of a plurality of users of a social network;
determine that a particular user of the plurality of users has performed the particular action;
in response to determining that the particular user has performed the particular action, analyze information regarding the performance of the particular action by one or more other users of the plurality of users after the performance of the particular action by the particular user; and
determine whether the particular user is a leader based at least on the analysis of the subsequent performance of the particular action by the one or more other users.

11. The apparatus of claim 10, wherein the action log includes a plurality of tuples, each tuple setting forth an action, a user that has performed the action, and a time at which the user performed the action.

12. The apparatus of claim 10, wherein the computer-executable instructions for determining whether the particular user is a leader based at least on the analysis of the subsequent performance of the particular action by the one or more other users includes computer-executable instructions for determining whether an actual number of users that performed the particular action after the particular user exceeds an influence threshold.

13. The apparatus of claim 12, wherein the computer-executable instructions for determining whether the particular user is a leader based at least on the analysis of the subsequent performance of the particular action by the one or more other users includes computer-executable instructions for determining whether the actual number of users that performed the particular action within a propagation time threshold after the performance of the particular action by the particular user in order to determine whether the particular user is a leader.

14. The apparatus of claim 10, wherein the computer-executable instructions for determining whether the particular user is a leader based at least on the analysis of the subsequent performance of the particular action by the one or more other users includes computer-executable instructions for:
determining a first actual number of actions for which the particular user is a genuine leader, wherein the particular user is a genuine leader with respect to each action if the particular user is a leader with respect to such action and did not perform such action within a propagation time threshold after performance of such action by another user;
determining a second actual number of actions for which the particular user is a leader, regardless of whether the particular user is a genuine leader for such actions;
determining a genuineness ratio, wherein the genuineness ratio is defined as the ratio of the first actual number to the second actual number; and
determining whether the genuineness ratio exceeds a genuineness threshold.

15. The apparatus of claim 10, wherein the computer-executable instructions for determining whether the particular user is a leader based at least on the analysis of the subsequent performance of the particular action by the one or more other users includes computer-executable instructions for determining whether the particular user is a genuine leader with respect to the particular action, wherein the particular user is a not genuine leader with respect to a particular action if the particular user performed the action within a propagation time threshold after performance of the particular action by another use.

16. The apparatus of claim 10, wherein the computer-executable instructions for determining whether the particular user is a leader based at least on the analysis of the subsequent performance of the particular action by the one or more other users includes computer-executable instructions for determining whether an actual number of actions performed by the actual number of users after performance of the actions by the particular user exceeds an action threshold in order to determine whether the particular user is a leader.

17. The apparatus of claim 10, wherein the computer-executable instructions for determining whether the particular user is a leader based at least on the analysis of the subsequent performance of the particular action by the one or more other users includes computer-executable instructions for:
determining a first actual number of actions for which the particular user is a leader;
determining a second actual number of actions performed by the particular user;
determine a confidence ratio, wherein the confidence ratio is defined as the ratio of the first actual number to the second actual number; and
determining whether the confidence ratio exceeds a confidence threshold;
in order to determine whether the particular user is a leader.

18. The apparatus of claim 10, further including computer-executable instructions for determining whether the particular user is a tribe leader, the computer-executable instructions including computer-executable instructions for:
determining a first number of actions performed by the one or more other users within a propagation time threshold after performance of each action by the particular user;
determining a second number of one or more other users performing the number of actions within the propagation time threshold;
identifying the particular user as a tribe leader based at least on the first number and the second number.

19. An article of manufacture comprising:
a computer readable medium; and
computer-executable instructions carried on the computer readable medium, the instructions readable by a processor, the instructions, when read and executed, for causing the processor to:
analyze an action log including information regarding the performance of a particular action by each of a plurality of users of a social network;
determine that a particular user of the plurality of users has performed the particular action;
in response to determining that the particular user has performed the particular action, analyze information regarding the performance of the particular action by one or more other users of the plurality of users after the performance of the particular action by the particular user; and
determine whether the particular user is a leader based at least on the analysis of the subsequent performance of the particular action by the one or more other users.

20. The article of manufacture of claim 19, further including computer-executable instructions for determining whether the particular user is a tribe leader, the computer-executable instructions including computer-executable instructions for:
determining a first number of actions performed by the one or more other users within a propagation time threshold after performance of each action by the particular user;
determining a second number of one or more other users performing the number of actions within the propagation time threshold;
identifying the particular user as a tribe leader based at least on the first number and the second number.
